(19) United States
(12) Patent Application Publication
(10) Pub. No.: US 2008/0012438 A1
(43) Pub. Date: Jan. 17, 2008

(54) Hermetic type compressor and manufacturing method thereof

(75) Inventor: Myung Jung Hong, Seo-gu (KR)

Correspondence Address: BLANK ROME LLP, 600 NEW HAMPSHIRE AVENUE, N.W., WASHINGTON, DC, 20037, US

(73) Assignee: Samsung Gwangju Electronics CO., Ltd.

(21) Appl. No.: 11/812,372

(22) Filed: Jun. 18, 2007

(30) Foreign Application Priority Data
Jul. 13, 2006 (KR) 2006-65833

(51) Int. Cl. H02K 15/10; F04B 17/03; H02K 11/00

(52) U.S. Cl. 310/71; 29/596; 29/888.02; 417/410.1

(57) ABSTRACT

A hermetic type compressor in which manufacturing costs can be reduced, wherein a connection between stator coils wound around a stator and lead wires of a terminal block, is prevented from being cut, and a manufacturing method of the same. The compressor includes a sealed casing, a compression device, a driving unit having a stator, including stator coils wound around a core and a rotor rotating within the stator to drive the compression device, lead wires extended from a terminal block coupled with the a terminal installed to the sealed casing to supply electric current, and a connected part formed by which the stator coils are made by coating aluminum wires with enamel, the ends of the stator coils whose enameling is removed are connected to the lead wires to supply the electric current, and the entire ends of the aluminum wires whose enameling is removed and exposed are inserted into a joint band to connect the ends of the stator coils to ends of the lead wires.

### CROSS-REFERENCE TO RELATED APPLICATION

This application claims the benefit of Korean Patent Application No. 2006-65833, filed on Jul. 13, 2006, in the Korean Intellectual Property Office, the disclosure of which is incorporated herein by reference.

### BACKGROUND OF THE INVENTION

1. Field of the Invention

The present invention relates to a hermetic type compressor and a manufacturing method thereof, and more particularly to a hermetic type compressor in which manufacturing costs can be reduced and problems occurring during the connection of lead wires of a stator coil wound around a stator and a terminal block can be solved and a manufacturing method thereof.

2. Description of the Related Art

Generally, a hermetic type compressor includes a sealed casing to form a sealed chamber, a compression device provided in the sealed casing to compress a refrigerant, and a driving unit to drive the compressing device.

Among the components, the driving unit to supply a driving force to the compressing device includes a stator fixed in the sealed casing and a rotor inwardly spaced apart from the stator to electromagnetically interact with the stator. The overall driving unit serves as a motor.

The stator of the driving unit is fabricated by winding a plurality of stator coils around a core such that the stator coils are connected to lead wires of the terminal block, and the terminal block is coupled with terminals provided in the sealed casing to be supplied with electric power. As such, the stator coils are prepared by coating single copper wires with enamel so as to prevent an electric short with other stator coils.

However, an increase in the cost of copper increases the manufacturing costs of the hermetic type compressor employing the stator coils made of copper.

Meanwhile, in order to connect a plurality of lead wires extended from the plurality of stator coils and the terminal block to each other respectively, the ends of the stator coils and ends of the lead wires are connected to each other with joint bands.

As such, in order to connect the ends of the stator coils to the ends of the lead wires such that electric current flows to the stator coils, the copper wires are exposed by removing the enamel coating from the stator coils, and the ends of the coating-removed copper wires are then connected to the ends of the lead wires with the joint bands.

In this case, since the coating-removed copper wires are long so as to secure conduction of the stator coils, some of the coating-removed copper wires are inserted into and pressed by the joint band, thus, the rest of the coating-removed copper wires are exposed to the outside.

### SUMMARY OF THE INVENTION

The present invention has been made in view of the above-mentioned problems. One aspect of the invention is to provide a hermetic type compressor that is manufactured at lower costs, and a manufacturing method thereof.

It is another aspect of the invention to provide a hermetic type compressor in which disconnection between lead wires extending from the stator coil and a terminal block, which would occur when material for a stator coil is changed, is solved, and a manufacturing method thereof.

In accordance with one embodiment of the invention, the present invention provides a hermetic type compressor including a sealed casing; a compression device; a driving unit having a stator including stator coils wound around a core and a rotor rotating within the stator to drive the compression device; lead wires extended from a terminal block coupled with a terminal installed on the sealed casing to supply electric current; and a connected part formed by which the stator coils are made by coating aluminum wires with enamel, wherein the ends of the stator coils whose enameling is removed are connected to the lead wires to supply the electric current, and wherein the entire ends of the aluminum wires whose enameling is removed and exposed are inserted into a joint band to connect the ends of the stator coils to the ends of the lead wires.

Moreover, the lead wires are made by coating copper wires with a coating material, such that the coating is removed from the ends of the lead wires, and the aluminum wires from which the enameling is removed and the copper wires from which the coating is removed are inserted into the joint band to be overlapped with each other, whereby the joint band is then pressed.

In accordance with another embodiment of the invention, the present invention provides a hermetic type compressor including a sealed casing; a compression device; a driving unit having a stator including stator coils wound around a core and a rotor rotating within the stator to drive the compression device; lead wires extended from a terminal block coupled with a terminal installed on the sealed casing to supply electric current; and a connected part formed whereby the stator coils are made by coating aluminum wires with enamel, the ends of the stator coils whose enameling is removed are connected to the lead wires to supply the electric current, the ends of the enameling is inserted into a joint band to connect the ends of the stator coils to the lead wires, whereby the joint band is then pressed.

In accordance with another embodiment of the invention, the present invention provides a method of manufacturing a hermetic type compressor having the steps of coating aluminum wires with enamel to form stator coils; removing the enameling from ends of the stator coils; removing coating from lead wires extended from a terminal block coupled with a terminal installed to a sealed casing; inserting the entire aluminum wires whose enameling is removed into a joint band to connect the ends of the stator coils to the ends of the lead wires; and pressing the joint band to connect the stator coils to the lead wires.

The method further comprises overlapping the aluminum wires whose enameling is removed with the copper wires whose coating is removed within the joint band.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1 is a sectional view drawing illustrating a hermetic type compressor according to an embodiment of the present invention;

FIG. 2 is a perspective view drawing illustrating the connection between lead wires of stator coils and a terminal block of the hermetic type compressor in FIG. 1; and

FIG. 3 is an enlarged view drawing illustrating a connected part where the lead wires of the stator coils and the terminal block are connected.

### DETAILED DESCRIPTION OF THE PREFERRED EMBODIMENTS

Hereinafter, a hermetic type compressor according to embodiments of the present invention will be described in detail with reference to the accompanying drawings.

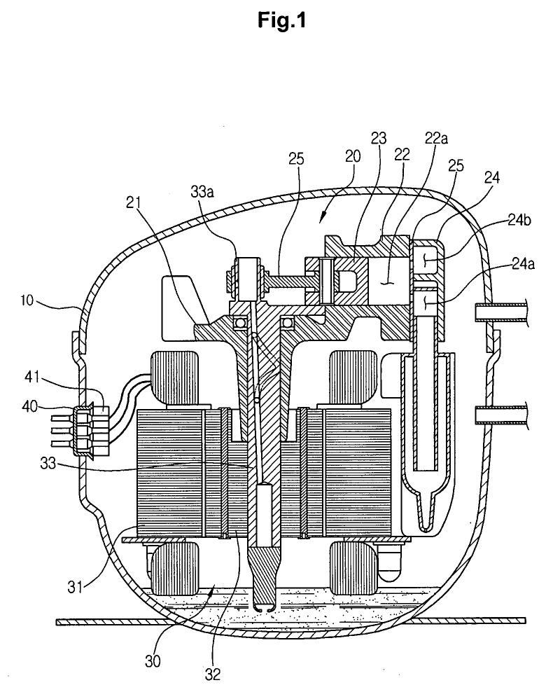

A hermetic type compressor according to an embodiment of the present invention, as illustrated in FIG. 1, includes a sealed casing 10 that forms a sealed chamber, a compressing device 20 disposed in the sealed casing 10 to compress a refrigerant, and a driving unit 30 to drive the compressing device 20.

The compressing device 20 includes a cylinder block 22 integrated with a frame 21 and having a compression chamber 22a formed in a side thereof, a piston 23 to reciprocate within the compression chamber 22a to compress the refrigerant, a cylinder head 24 coupled with a side of the cylinder block 22 and having a suction chamber 24a and a discharge chamber 24b, and a valve device 25 disposed between the cylinder block 22 and the cylinder head 24 to control the refrigerant entering and discharging from the compression chamber 22a.

The driving unit 30 reciprocates the piston 23 such that the refrigerant is compressed in the compression device 20, and includes a stator 31 to generate a magnetic field, a rotor 32 inwardly spaced apart from the stator 31 to electromagnetically interact with the stator 32, a rotation shaft 33 fitted into the center of the rotor 32 to be rotated with the rotor 32.

The rotation shaft 33 rotates within the frame 21 and includes an eccentric part 33a formed at a top end of the rotation shaft 33 and eccentrically rotated, and a connecting rod 25 installed between the eccentric part 33a and the piston 23 to convert the eccentric movement of the eccentric part 33a into a linear reciprocating movement of the piston 23.

Electric current is applied to the hermetic type compressor to generate a magnetic field around the stator 31, and the rotor 32 rotates due to the electromagnetic interaction with the stator 31. When the rotor 32 rotates, the rotation shaft 33 rotates along with the rotation shaft 32, and the rotational movement is converted into the linear reciprocating movement by the eccentric part 33a and the connecting rod 25 such that the piston 23 compresses the refrigerant in the compression chamber 22a.

Meanwhile, in order to supply electric current to the stator 31, the sealed casing 10 includes a terminal 40 connected to an external power source. The terminal 40 is coupled with a terminal block 41 in the sealed casing 10.

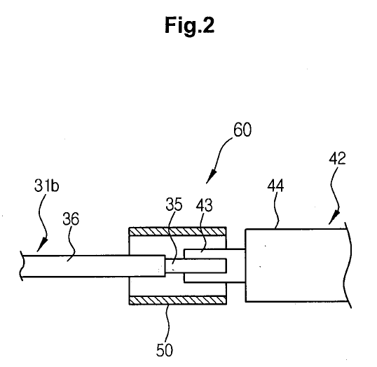

The stator 31 of the driving unit 30, as illustrated in FIG. 2, is fabricated by winding a plurality of stator coils 31b around a core 31a [31a is not shown on the drawings]. The respective stator coils 31b are fabricated by coating aluminum wires 35 with enamel 36.

Since the stator coils 31b wound around the core 31a are very long, a great deal of material for the stator coils 31b is required. Thus, when aluminum, is used to fabricate the stator coils 31b, the manufacturing costs of the hermetic type compressor can be reduced because the price of Aluminum is one third the price of copper.

Meanwhile, a plurality of lead wires 42 extend from an end of the terminal block 41 that is coupled with the terminal 40. The lead wires 42 are fabricated by coating copper wires 43 with coating material. The copper wires are fabricated with a plurality of twisted fine copper strands.

In order to supply electric current to the stator 31, ends of the stator coils 31b of the stator 31 are respectively connected to ends of the lead wires 42 extended from the terminal block 41 to form connected parts 60.

In order to connect the stator coils 31b to the lead wires 42, cylindrical joint bands 50 are used. Prior to connecting them between the stator coils 31b and the lead wires 42, the enameling 36 is removed from the ends of the stator coils 31b to expose the aluminum wires 35. Also, the coating 44 is removed from the ends of the lead Wires 42 to expose the copper wires 43.

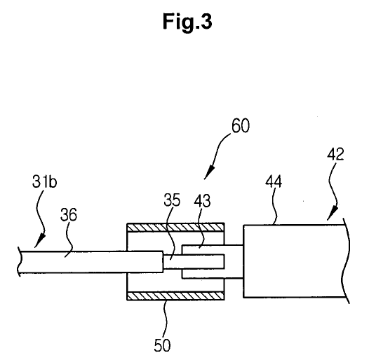

However, at room temperature the tensile strength of copper is 22 kg/mm² and the tensile strength of aluminum is just 10 kg/mm². Thus, there is a need for a structure to reinforce the tensile strength of the stator coils 31b where the aluminum wires 36 from which the enameling 36 is removed is connected to the copper wires 43 from which the coating 44 is removed. The reinforcing structure will be described with reference to FIG. 3.

As illustrated in FIG. 3, an end of a stator coil 31b and an end of a lead wire 42 are inserted into the joint band 50. In this case, the entire aluminum wire 35 without the enameling 36 of the stator coil 31b is inserted into the joint band 50 such that some of the aluminum wire 35 without the enameling 36 and the copper wire 43 without the coating 44 overlap with each other.

As such, in a state when the entire aluminum wire 35 without the enameling 36 is inserted into the joint band 50, the joint band 50 is pressed by a pressing device (not shown) to form the connected part 60 such that the end of the stator coil 31b and the end of the lead wire 42 are connected to each other.

When the connected part 60 is formed, it is possible to prevent the aluminum wire 35, from which the enameling 36 is removed, and which has a low tensile strength, from being cut off, since the joint band 50 is thicker than the aluminum wire 35 without the enameling 36 and is pressed together with the stator coil 31b, which has a high tensile strength and coated with the enameling 36.

Moreover, since the aluminum wire 35 without the enameling 36, and the copper wire 43 without the coating 44, are partially overlapped with each other, the electric current is securely supplied to the stator 31.

On the other hand, the copper wires 43 without the coating 44 are partially inserted into the joint bands 50, such that the rest may be exposed outside the joint bands 50. This is because the tensile strength of copper is higher than that of aluminum and the copper wires 43 are strands fabricated by twisting thin copper wires and are thicker than the aluminum wires 35 to have a relative high tensile strength.

As described above, according to the hermetic type compressor of the present invention, since the stator coils of the stator are fabricated with aluminum, which is less expensive than copper, the manufacturing costs of the compressor can be reduced.

Moreover, since the entire exposed part of the aluminum wires, used as the stator coils, whose enameling is removed is inserted into the joint bands to form the connected part, the tensile strength of the stator coils can be guaranteed. Thus, it is possible to prevent the hermetic type compressor from malfunctioning due to the short-circuiting of the connected part between the stator coils and the lead wires.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A hermetic type compressor comprising:
a sealed casing;
a compression device inside the sealed casing;
a driving unit comprising a stator, the stator including stator coils wound around a core and a rotor rotating within the stator to drive the compression device;
lead wires extended from a terminal block coupled with a terminal that is attached to the sealed casing for supplying electric current; and
a connected part formed by coating a plurality of aluminum wires with enamel, removing from the ends of a plurality of stator coils an enameling, connecting the ends to the lead wires to supply the electric current, wherein the entire ends of the plurality of aluminum wires whose enameling is removed and exposed are inserted into a joint band to connect the ends of the stator coils to the ends of the lead wires.

2. The hermetic type compressor according to claim 1, wherein the lead wires are made by coating copper wires with a coating material, wherein the coating is removed from the ends of the lead wires, and wherein the aluminum wires from which the enameling is removed and the copper wires from which a coating is removed are inserted into the joint band to be overlapped with each other, and wherein the joint band is pressed.

3. A hermetic type compressor comprising:
a sealed casing;
a compression device inside the sealing casing;
a driving unit comprising a stator, the stator including stator coils wound around a core and a rotor rotating within the stator to drive the compression device;
lead wires extended from a terminal block coupled with a terminal that is attached to the sealed casing for supplying electric current; and
a connected part formed by coating a plurality of aluminum wires with enamel, removing from the ends of a plurality of stator coils an enameling, connecting to the lead wires to supply the electric current, wherein the ends with the enameling removed are inserted into a joint band to connect the ends of the stator coils to the lead wires, and wherein the joint band is pressed.

4. A method of manufacturing a hermetic type compressor comprising:
coating aluminum wires with enamel to form stator coils;
removing a portion of the enameling from the ends of the stator coils;
removing a portion of a coating from a plurality of lead wires extended from a terminal block coupled with a terminal installed on a sealed casing;
inserting the entire ends of the aluminum wires whose enameling has been removed into a joint band to connect the ends of the stator coils to the ends of the lead wires; and
pressing the joint band to connect the stator coils to the lead wires.

5. The method of manufacturing a hermetic type compressor according to claim 4, further comprising overlapping within the joint band the aluminum wires whose enameling has been removed with the lead wires whose coating has been removed.
